(19) United States
(12) Patent Application Publication
(10) Pub. No.: US 2019/0163731 A1
(43) Pub. Date: May 30, 2019

(54) METHODS AND SYSTEMS FOR ANNOTATING A DASHBOARD

(71) Applicant: Dundas Data Visualization, Inc., Toronto (CA)

(72) Inventors: Robert E. Siklos, Toronto (CA); Stanislav Kashepava, Toronto (CA); Troy A. Marchand, Nobleton (CA)

(21) Appl. No.: 16/166,776

(22) Filed: Oct. 22, 2018

Related U.S. Application Data
(63) Continuation of application No. 15/631,138, filed on Jun. 23, 2017, now abandoned.
Application No. 15/631,138 is a continuation of application No. 14/918,056, filed on Oct. 20, 2015, now abandoned.
Application No. 14/918,056 is a continuation of application No. 13/082,512, filed on Apr. 8, 2011, now abandoned.
(60) Provisional application No. 61/430,434, filed on Jan. 6, 2011.

(51) Int. Cl. G06F 17/24; G06F 16/22; G06Q 10/06; G06F 16/28

(52) U.S. Cl. CPC G06F 17/241; G06F 16/285; G06Q 10/06393; G06F 16/2282

(57) ABSTRACT

A dashboard generation system generates a dashboard that displays an annotation to key performance indicator information. The dashboard generation system uses a business database, an intermediate table, an annotation associated with a dimension category, and formatting data to generate a dashboard. The dashboard generator determines a dimension category and renders the intermediate values and annotations in the corresponding desired graphical format.

### CROSS-REFERENCE TO RELATED APPLICATIONS

This application is a continuation of U.S. patent application Ser. No. 15/631,138, filed Jun. 23, 2017, which is a continuation of U.S. patent application Ser. No. 14/918,056, filed Oct. 20, 2015, which is a continuation of U.S. patent application Ser. No. 13/082,512, filed Apr. 8, 2011, which claims the benefit of U.S. provisional patent application no. 61/430,434, filed Jan. 6, 2011. The entire contents of U.S. patent application Ser. No. 15/631,138, U.S. patent application Ser. No. 14/918,056, U.S. patent application Ser. No. 13/082,512 and U.S. provisional patent application no. 61/430,434 are hereby incorporated by reference.

### TECHNICAL FIELD

The described embodiments relate generally to methods and systems for dashboard presentation.

### BACKGROUND

“Dashboards” present visualizations, for example, in graph or chart form, of key performance indicator (KPI) metrics or information derived from business values or data stored in business databases. Such visualizations may be viewed (e.g., on a computer screen or other display device) by executives to obtain an overview of how a business is performing.

### BRIEF DESCRIPTION OF THE DRAWINGS

Embodiments are described in further detail below, by way of example only, with reference to the accompanying drawings, in which:

FIG. 1 is a block diagram of one possible configuration of a dashboard generation system, in accordance with one embodiment of the present disclosure;

FIG. 2 shows example tables having business values that may be stored in a business database;

FIGS. 3A and 3B are schematic illustrations of example intermediate tables having intermediate values;

FIG. 4 is an illustration of a dashboard showing an annotated visualization of KPI values corresponding to the intermediate values of FIG. 3A;

FIG. 5 is an illustration of a dashboard showing an altered version of the annotated visualization of FIG. 4;

FIG. 6 illustration of a dashboard showing annotated visualizations of KPI values corresponding to the intermediate values of FIG. 3B;

FIGS. 7A and 7B are illustrations of a dashboard showing an altered version of the annotated visualization of FIG. 6; and

FIG. 8 is a flowchart illustrating a sequence of events for annotating a dashboard, in accordance with an embodiment of the present disclosure.

### DETAILED DESCRIPTION

When creating a dashboard, it would be useful for a business analyst to be able to provide comments or otherwise highlight a value of a KPI. Such “annotations” may, for example, provide contextual or background information for the highlighted value. For example, in a KPI depicting total sales for different types of products, a business analyst may wish to indicate why sales for a certain product may be underperforming.

When viewing dashboards, it may also be useful to alter or modify visualizations of a KPI. For example, a KPI visualization showing sales over many months may be consolidated to show sales over several quarters. In another example, a KPI visualized as a bar chart may be re-visualized as a pie chart.

The embodiments described herein associate an annotation with a dimension category (i.e., a particular field, property or characteristic of data that may allow sorting, grouping or filtering) of the KPI information. In doing so, the described embodiments may display an annotation whenever data related to the dimension category is displayed. That is, if a dashboard showing a KPI value associated with one visualization is altered so that the KPI value is shown in another visualization, the same annotation may still be displayed.

For example, a dimension category may be a sporting goods product type such as a SKI. If a visualization showing total sales for the SKI product type is annotated when it is rendered as a bar chart, the embodiments described herein may allow the annotation to still be displayed if the visualization is altered to be rendered as a pie chart—so long as the annotated KPI value for the same SKI dimension category is rendered.

The embodiments described herein provide in one aspect, a dashboard generation system for generating a dashboard displaying an annotation to key performance indicator information. The dashboard generation system can include: a business database comprising a plurality of business values and an intermediate table.

The intermediate table may include: a plurality of intermediate values with each intermediate value corresponding to at least one of the business values and a plurality of dimension categories. Each dimension category may, in turn, correspond to a unique group of at least one intermediate value.

The dashboard generation system may further include: at least one annotation with each annotation associated with at least one dimension category; and key performance indicator format data for each dimension category, the format data corresponding to a desired graphical format for depicting the corresponding unique group of at least one intermediate value.

With the above data, a dashboard generator can then generate a dashboard. In doing so, the dashboard generator may be configured to: determine a dimension category from the plurality of dimension categories; render the unique group of at least one intermediate value corresponding to the determined dimension category, in the corresponding desired graphical format; and render any annotation corresponding to the determined dimension category.

In some embodiments, the dashboard generator may further comprise a renderer. Additionally or alternatively, one of the dimension categories can correspond to a plurality of the other dimension categories. In some embodiments, at least one of the plurality of intermediate values corresponds to a plurality of the business values.

Some annotations may include a date range. If so, the dashboard generator can be configured to determine, for any annotation corresponding to a determined dimension category, if any of the at least one intermediate value corresponding to the determined dimension category corresponds to the date range for the annotation. The dashboard generator can then be configured to: render, as a plurality of data points, the at least one intermediate value corresponding to the date range of the annotation, and render the annotation in association with the plurality of data points.

The embodiments described herein provide in another aspect, a dashboard comprising the rendered unique group of at least one intermediate value in the corresponding desired graphical format and a corresponding annotation, generated by the dashboard generation system.

The embodiments described herein provide in a further aspect, a method for generating a dashboard displaying an annotation to key performance indicator information. The method may include: providing a plurality of business values; and creating an intermediate table comprising intermediate data. The intermediate data can include a plurality of intermediate values with each intermediate value corresponding to at least one of the business values, and a plurality of dimension categories with each dimension category corresponding to a unique group of at least one intermediate value.

Additionally, the method may involve: generating at least one annotation that is associated with at least one dimension category; and determining a key performance indicator format for each dimension category. The format can correspond to a desired graphical format for depicting the corresponding unique group of at least one intermediate value.

Furthermore, the method may include: determining a dimension category; rendering the unique group of at least one intermediate value corresponding to the determined dimension category, in the corresponding desired graphical format; and rendering any annotation corresponding to the determined dimension category.

In some embodiments, one of the dimension categories corresponds to a plurality of the other dimension categories. Additionally or alternatively, at least one of said plurality of intermediate values corresponds to a plurality of the business values.

In some instances, at least one of the plurality of intermediate values may comprise a summary value corresponding to an analysis of a selected subset of business values. In such case, the summary value may be determined using a database query of the plurality of business values.

In some embodiments, at least one annotation comprises a date range. In such case, the method may further include: determining, for any annotation corresponding to the determined dimension category, if any of the at least one intermediate value corresponding to the determined dimension category also corresponds to the date range for the annotation. The method may then further include rendering, as a plurality of data points, the at least one intermediate value corresponding to the date range of the annotation, and rendering the annotation in association with the plurality of data points.

The embodiments described herein provide in another aspect, a dashboard including the rendered unique group of at least one intermediate value in the corresponding desired graphical format and a corresponding annotation, as generated by the dashboard generation method.

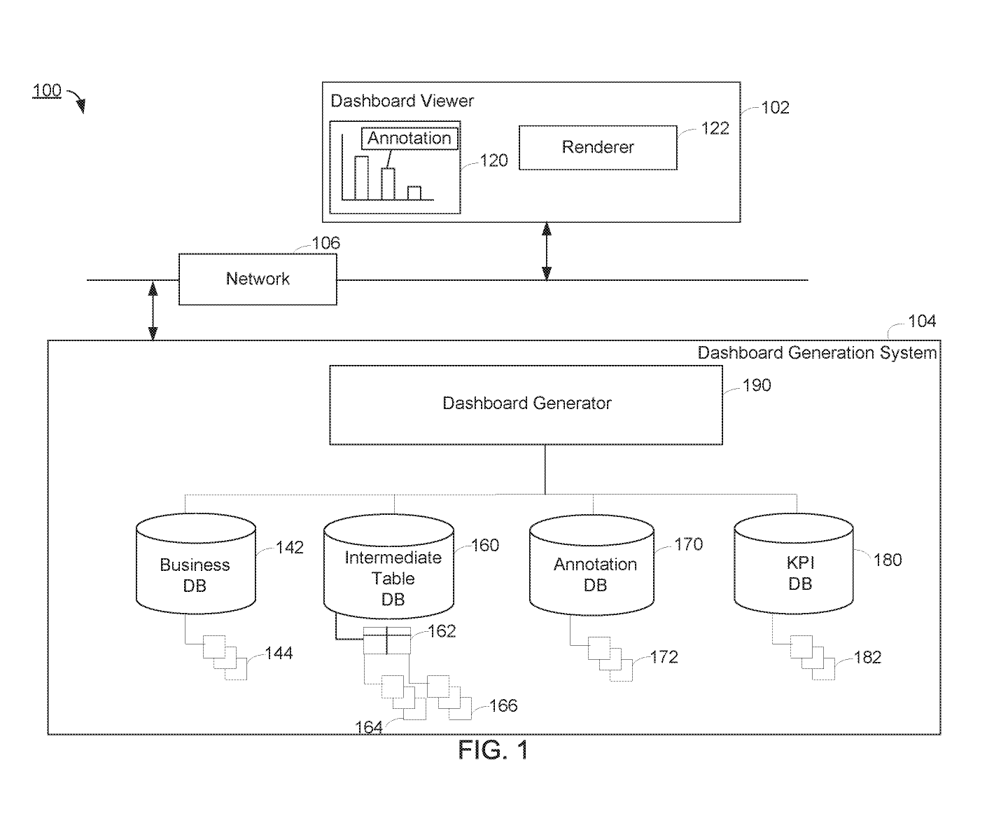

Referring to FIG. 1, shown there is a block diagram of one possible configuration of a dashboard generation system, shown generally as 100, in accordance with one embodiment of the present disclosure. The system 100 may include a dashboard viewer 102 and a dashboard generation system 104, each of which may be connected to a network 106 to facilitate communication with each other. In some embodiments, the dashboard viewer 102 and dashboard generation system 104 may operate in a client-server architecture according to known methods.

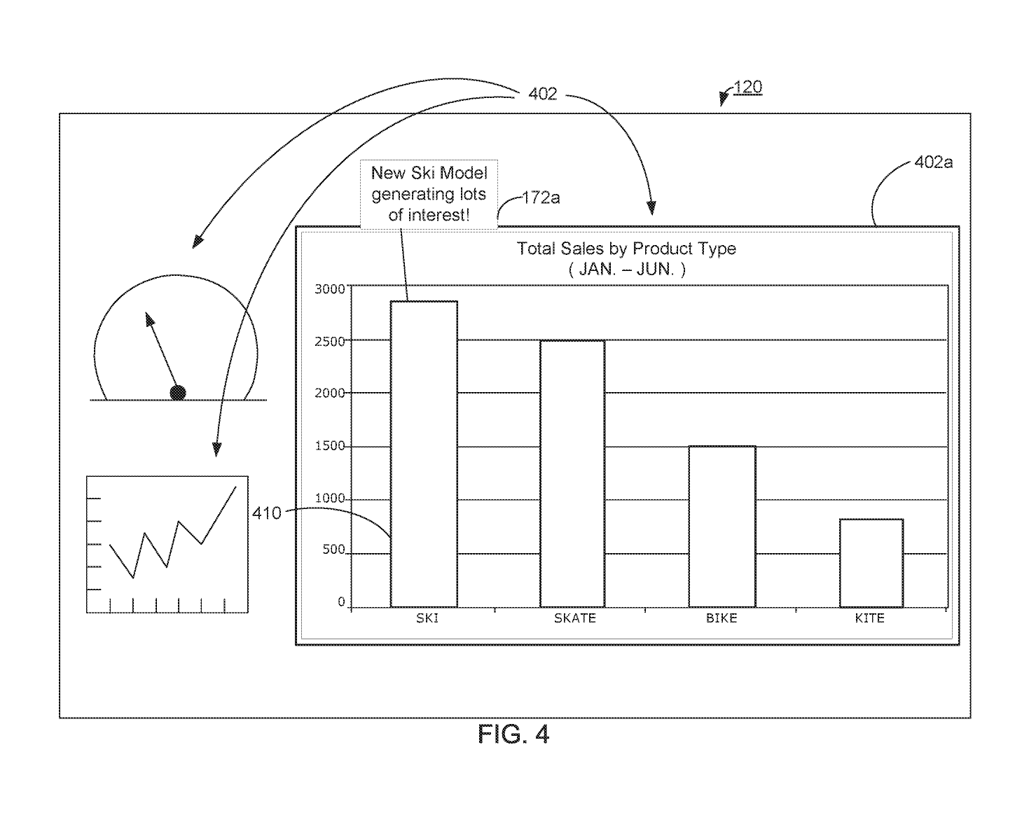

The dashboard viewer 102 may include a renderer 122 configured to render a dashboard 120 having an annotation. The dashboard 120 and the annotation may be generated by the dashboard generation system 104. The dashboard 120 may be viewed at the dashboard viewer 102 with, for example, a web browser or a standalone application (not shown). Referring briefly to FIG. 4, shown there is an example dashboard 120 containing a KPI visualization 402a showing total sales by product, in which there is an annotation for the total sales for a SKI product.

Dashboard generation system 104 may include a business database 142, an intermediate table database 160, an annotation database 170, a KPI database 180 and a dashboard generator 190.

The dashboard 120 may typically be generated by several individuals in a business organization. A database administrator may first assist in selecting intermediate values 164 from the business database 142. In doing so, they may use their specialized knowledge of the layout (e.g., the schema or data types associated with particular records) of the business database 142 to select intermediate values 164 that can be used in the subsequent identification of a KPI. A business analyst may then determine the KPI that is useful for an end user or viewer of the dashboard 120 to view. The KPI may, for example, be the ‘Total Sales by Product Type’ visualized in FIG. 4. The business analyst may identify dimension categories 166 to process the intermediate values 164 into KPI values. After the KPI values have been derived, a graphic designer may select a desired graphical format for depicting the KPI values in a KPI visualization. During the dashboard development process, the business analyst may provide an annotation so that an end user (e.g., a business executive) may see it when the dashboard 120 is completed.

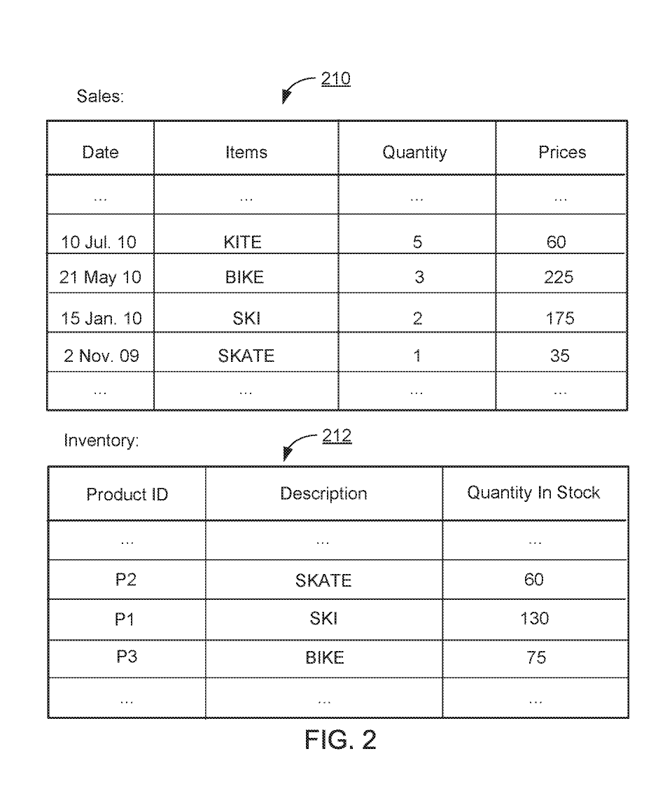

The business database 142 may store a plurality of business values 144 (e.g., sales, expenses, inventory or human resources data) that relate to the operation of a business. As an illustration, the business database 142 may be an accounting and inventory management database that stores transactional data for a sporting goods store. Referring briefly to FIG. 2, shown there are exemplary excerpts from a ‘Sales’ table 210 and an ‘Inventory’ table 212 that may be stored in an example business database 142. In some embodiments, the business database 142 may be stored on a separate computer accessible by the dashboard generation system 104.

The intermediate table database 160 may store an intermediate table 162. The intermediate table 162 may include intermediate data having: one or more of intermediate values 164 corresponding to at least one business value 144, and one or more dimension categories 166. In some embodiments, the intermediate table 162 may be a virtual table generated as a part of a database query such as a SQL query.

The intermediate values 164 may be a subset of business values 144 selected from the business database 142. This subset may be formatted to facilitate the identification and derivation of KPI values for visualization. For example, such formatting may include providing the intermediate values 164 in an intermediate table 162 that has joined multiple tables to consolidate business values 144 that may otherwise be difficult to access or view. In some cases, the intermediate values 164 may be generated by performing a summation or other mathematical process on the business values 144.

As discussed in greater detail below, a dimension category 166 may correspond to a property or characteristic of intermediate values 164 that allows filtering, sorting or grouping of intermediate values 164. That is, each dimension category 166 may be associated with a unique group of intermediate values 164. For example, a dimension category 166 may be a product type (e.g., all downhill skis grouped together as a dimension category “SKI” in stock at a sporting goods store) that allows monthly sales to be separated according to the product type. Viewed another way, there may be a unique group of intermediate values 164 that correspond to the monthly sales for a SKI product type.

As intermediate values 164 in an intermediate table 162 may have multiple properties or fields that are capable of being used as dimension categories 166, a database administrator may pre-select or otherwise identify the dimension categories 166 available for association with annotations 172. When an annotation 172 is subsequently supplied by a business analyst, the business analyst may be able to select the dimension category 166 from a list that the database administrator has provided.

The annotation database 170 may store at least one annotation 172. An annotation 172 may, for example, be a text comment providing background information for the corresponding annotated KPI value in the dashboard 120. Each annotation 172 may be associated with at least one dimension category 166 so that when a KPI value corresponding to the associated dimension category 166 is displayed, the annotation 172 would also be displayed. Referring briefly again to FIG. 4, shown there is an annotation 172a for the sales of a SKI product indicating that “New SKI model generating lots of interest!”

The KPI database 180 may store key performance indicator format data 182 for each dimension category 166. The format data 182 may correspond to a desired graphical format (e.g., a gauge, bar chart, pie chart, data grid, or text list) for depicting the intermediate values 164 corresponding to a dimension category 166.

The dashboard generator 190 may be configured to retrieve data from the illustrated business database 142, intermediate table database 160, annotation database 170 and key performance indicator database 180 to generate a dashboard 120. The dashboard generator 190 may perform several tasks when generating a dashboard 120, described below.

The dashboard generator 190 may select or otherwise determine the dimension category 166 for the intermediate values 164 that are desired to be displayed. The input triggering the determination of this dimension category 166 may, for example, be provided by a business analyst reviewing the intermediate values 164 when they are identifying which intermediate values 164 should form the KPI values for visualization. For example, a business analyst may wish to input a dimension category 166 for a product type dimension category 166 if the business analyst desires to view total sales by product types.

Once the dimension category 166 is determined, the dashboard generator 190 may render the intermediate values 164 corresponding to the determined dimension category 166, in the corresponding desired graphical format provided for in the format data 182. The format may be provided by a business analyst when they are deciding on the best way to visualize the KPI. Alternatively, the graphical format may be provided by a graphics designer tasked with determining the best way to visualize a KPI. It will be understood that the visualized KPI value(s) may correspond to the intermediate values 164 in that the visualized KPI value(s) may be grouped, filtered, mathematically processed (e.g., having identified the sum, average, minimum or maximum), or otherwise selected from the intermediate values 164.

The dashboard generator 190 may then render any annotation 172 corresponding to the determined dimension category 166.

In some embodiments, the discussed rendering steps may be performed by the renderer 122 residing at the dashboard viewer 102. In such case, the necessary data for rendering may be transmitted from the dashboard generator 190 to the renderer 122 via network 106.

The relationships amongst the various discussed components will now be explored in greater detail.

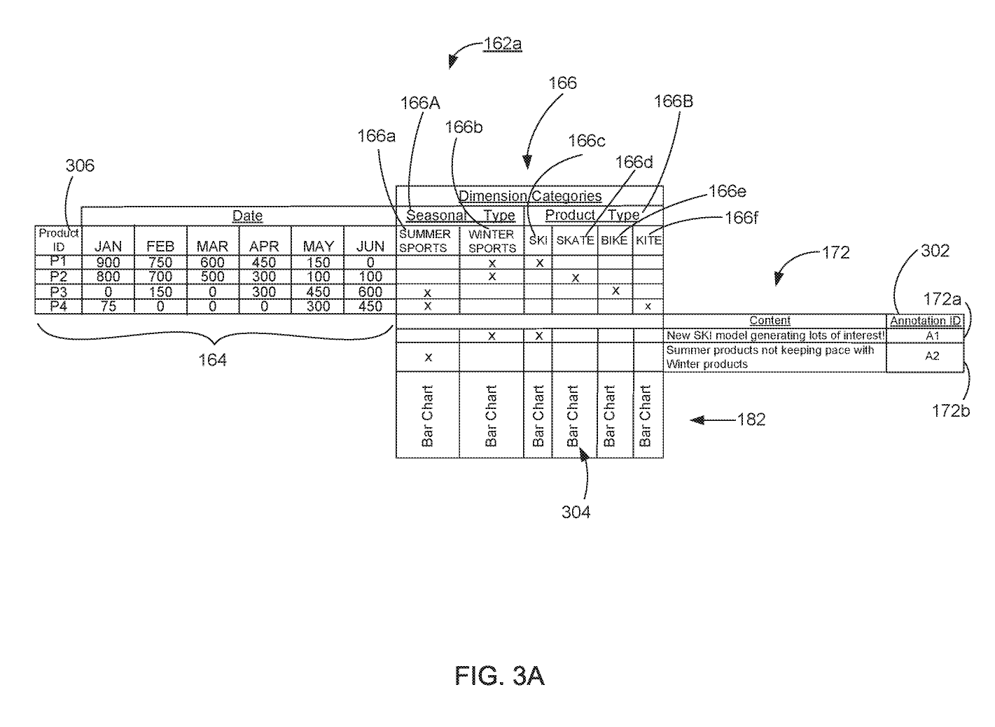

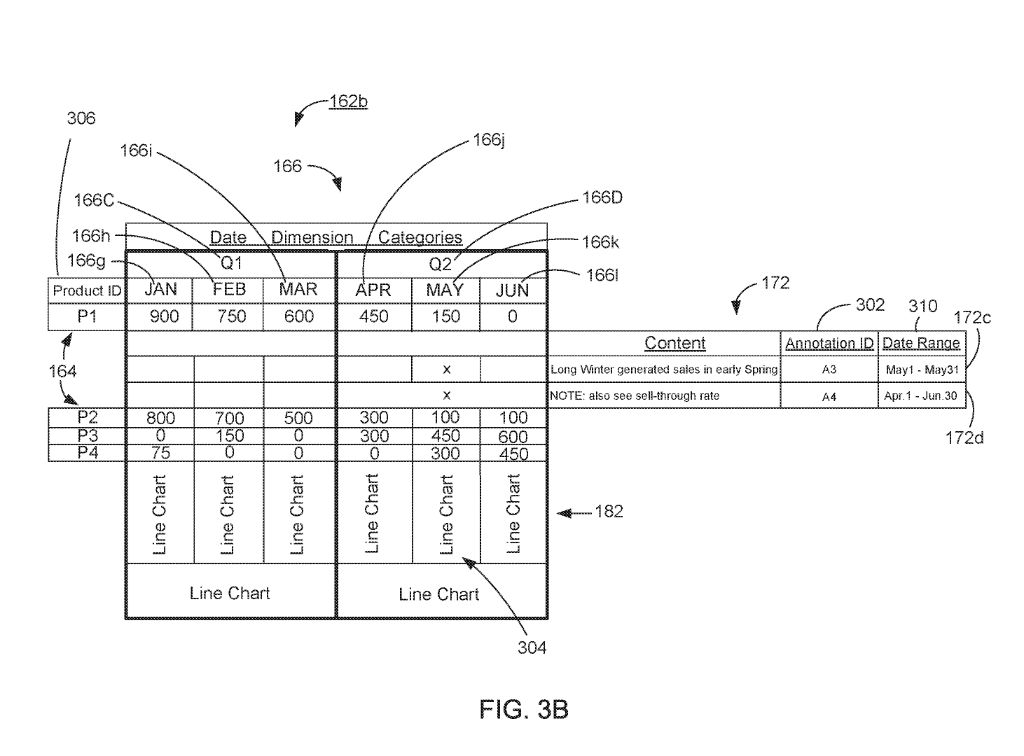

Referring to FIG. 3A, shown there generally as 162a is a schematic diagram with example data illustrating the various relationships amongst the intermediate table 162, intermediate values 164, dimension categories 166, annotations 172 and KPI format data 182.

The schematic diagram 162a illustrates the intermediate values 164 containing total monthly sales for various sporting goods products with product identifiers 306 ‘P1’, ‘P2’, ‘P3’ and ‘4’.

The dimension categories 166 are shown in columns adjacent to the intermediate values 164. As noted earlier, dimension categories 166 may be a property or characteristic of intermediate values 164 that allows filtering, sorting or grouping of intermediate values 164 identified by a database administrator when preparing the intermediate table 162. As illustrated, the dimension categories 166 may be seasonal types 166A (i.e., SUMMER SPORTS 166a and WINTER SPORTS 166b) or product types 166B (i.e., SKI 166c, SKATE 166d, BIKE 166e, KITE 166f).

An ‘X’ appears in the record for which a product is associated with the indicated dimension category 166. As illustrated, the product with product identifier 306 ‘P1’ may be associated with the SKI 166c and WINTER SPORT 166b product dimension categories, the product with product identifier 306 ‘P2’ may be associated with the SKATE 166d and WINTER SPORT 166b product dimension categories, the product with product identifier 306 ‘P3’ may be associated with the BIKE 166e and SUMMER SPORT 166a product dimension categories, and product with product identifier 306 ‘P4’ may be associated with the KITE 166f and SUMMER SPORT 166a product dimension categories.

FIG. 3A also illustrates the annotations 172 being associated with at least one dimension category 166. As illustrated, the annotations 172 are shown on the right of the indicated product category 166B columns, and an ‘X’ is shown in the record for which an annotation 172 is associated with the indicated dimension category 166. As illustrated, there are two annotations 172a, 172b, with annotation identifiers 302 ‘A1’ and ‘A2’ respectively: A1 is associated with the SKI 166c and WINTER SPORTS 166b dimension categories, and A2 is associated with the SUMMER SPORTS 166a dimension category. Although illustrated as a part of the intermediate table 162a, it will be understood that the annotations 172 may be stored separately in another table or database such as an annotation database 170 as earlier discussed.

FIG. 3A further illustrates the KPI format data 182 for depicting the intermediate values 164. This data 182 is illustrated as being associated with the dimension category 166 records. As illustrated, the desired graphical format 304 for each indicated ‘Product Type’ dimension category 166B (i.e., SKI 166c, SKATE 166d, BIKE 166e and KITE 166f) is a ‘Bar Chart’. It will be understood that while depicted as being associated with the dimension categories 166 in FIG. 3A, KPI format data 182 may be separately stored in a KPI database 180 as earlier discussed.

In some embodiments, the desired graphical formats 304 for each dimension category 166 may each correspond to a KPI graphical format associated with the KPI being visualized. For example, for the ‘Total Sales by Product Type’ KPI as discussed in FIG. 4 below, there may be a separate graphical format stored in the KPI database 180 to indicate that such KPI, as a whole, should be depicted as a ‘bar chart’. In such scenario, the various graphical formats 304 associated with the dimension categories 166 appearing in such KPI (e.g., the SKI 166c, SKATE 166d, BIKE 166e and KITE 166f dimension categories) may reflect the graphical format of the KPI.

The intermediate table 162 may provide a basis from which the business analyst may identify KPI values for visualization. For example, given the intermediate table 162 shown in FIG. 3A, a business analyst may wish to view the total sales for the first half of the year for each of the ‘Product Type’ 166B (i.e., SKI 166c, SKATE 166d, BIKE 166e and KITE 166f) dimension categories 166. Such KPI values may be derived from the intermediate values 164 by summing up the sales for the January to June months for each of the SKI 166c, SKATE 166d, BIKE 166e and KITE 166f dimension categories. In the example illustrated in FIG. 3A, this is the sales from January to June for each of the products with product identifiers 306 ‘P1’, ‘P2’, ‘P3’ and ‘P4’ respectively. These derived KPI values (i.e., the calculated totals) may then be depicted in a KPI visualization.

Referring to FIG. 4, shown there generally (as a part of an example dashboard 120) are visualizations 402 corresponding to KPI values derived from intermediate values 164. Particularly, the KPI visualization 402a corresponds to the KPI values derived from the intermediate values 164 of FIG. 3A. The visualization 402a depicts the total sales for the first half of the year 2010 for each of the SKI 166c, SKATE 166d, BIKE 166e and KITE 166f dimension categories. As illustrated, other visualizations 402 may include a gauge, a graph (e.g., line chart), a pie chart, or a data grid.

When depicting the KPI visualization 402, the KPI graphical format 304 associated with the dimension categories 166 being visualized may be used. In the example, since the desired graphical format 304 for the various SKI 166c, SKATE 166d, BIKE 166e and KITE 166f dimension categories indicate a graphical format 304 of a ‘bar chart’ is to be used, the visualization 402a is rendered as a ‘bar chart’. As illustrated, each of the SKI 166c, SKATE 166d, BIKE 166e and KITE 166f dimension categories have the same graphical format 304. However, it will be understood that in various embodiments, the graphical format 304 may differ for each dimension category 166 being displayed. In such case, the renderer 192 may be configured to render the KPI values corresponding to each dimension category 166 in the respective graphical format 304. Alternatively, a default graphical format 304 from the various graphical formats 304 associated with the selected dimension categories 166 may be selected for the visualization 402a. In further embodiments, as noted, a separate graphical format associated with the KPI itself may be used to depict the KPI visualization 402.

When visualized, it may be easier to see that in the first half of the year, SKIS 166c were the best selling product type 166B. To provide contextual information for this result, a business analyst may provide an annotation 172 (illustrated as an annotation 172a with identifier 302 ‘A1’ in FIG. 3A) associated with the SKI dimension category 166c. This annotation 172a can be seen in the visualization of FIG. 4, indicating that “New SKI model generating lots of interest!”

Several steps may be involved when rendering the dashboard 120 containing the illustrated KPI values and annotation 172. The dashboard generator 190 may first determine the dimension categories 166 that are desired to be rendered. In the example, with reference to FIG. 3A, the dashboard generator 190 can determine that the monthly sales for product with product identifier 306 ‘P1’ are associated with the SKI 166c product type dimension category 166c. The dashboard generator 190 may then render the intermediate values 164 (which in some embodiments, may have been further processed into KPI values) corresponding to the SKI product type by rendering the vertical bar 410 corresponding to the total SKI product type sales (i.e., the sum of the monthly sales intermediate values 164 for the product with product identifier 306 ‘P1’ for each of January to June). In some embodiments, the rendering of this group of intermediate values 164 may be performed in conjunction with the rendering of the rest of the intermediate values 164 in the KPI visualization 402a (e.g., the other total sales for the other product types in the bar chart 402a, for example). Subsequently, the dashboard generator 190 may render the annotation 172a corresponding to the SKI 166c product type dimension category.

Having seen the KPI visualization 402a illustrated in FIG. 4, a business analyst may want to see a more consolidated view of total sales. For example, he or she may wish to see total sales grouped by a ‘Seasonal Type’ 166A dimension category, and not just a ‘Product Type’ 166B dimension category. In altering the visualization, however, the analyst may wish the annotation to the SKI dimension category 166c to still be visible because it explains the underlying total sales for the WINTER SPORTS dimension category 166b.

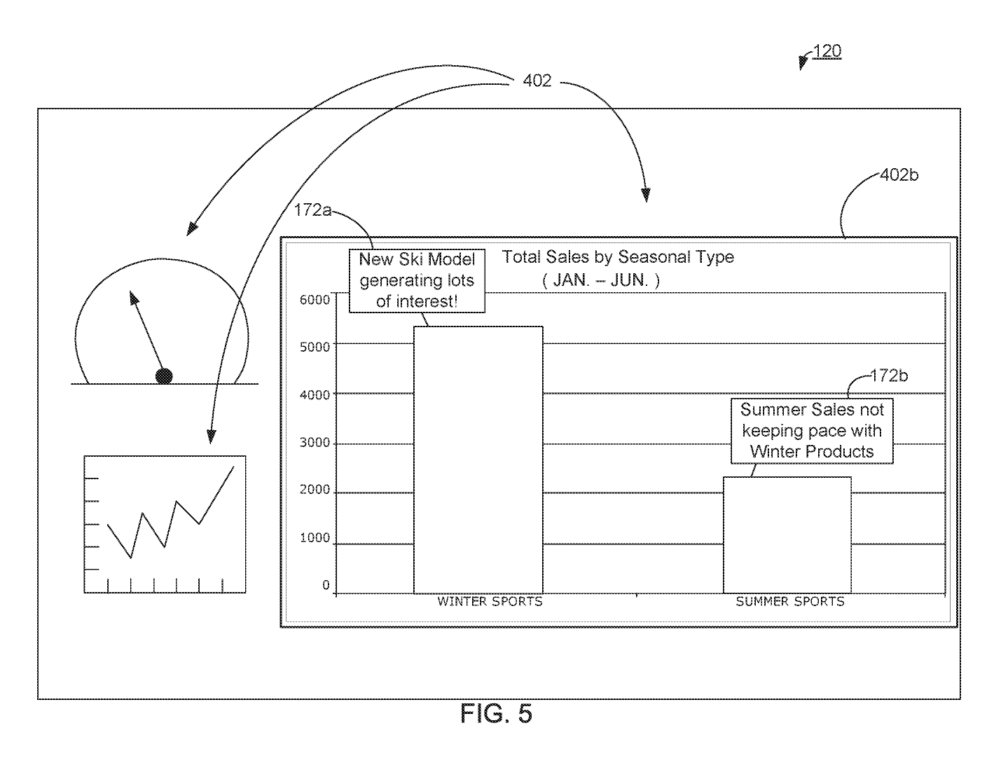

Referring to FIG. 5, shown there generally as 402b (as a part of an example dashboard 120) is an altered version of the visualization 402a shown in FIG. 4, consolidating total sales for the ‘Product Type’ 166B dimension categories into the ‘Seasonal Type’ 166A dimension categories. As illustrated, it can be seen that the sales for the products with product identifiers 306 ‘P2’ and ‘P2’ (which are associated with the WINTER SPORTS 166b dimension category) have been summed to provide the sales for the WINTER SPORTS 166b ‘Seasonal Type’ dimension category. Similarly, the sales for products with product identifiers 306 ‘P3’ and ‘P4’ have been grouped and summed to provide the total sales for the SUMMER SPORTS 166a ‘Seasonal Type’ category.

Since annotations 172a and 172b with annotation identifiers 302 ‘A1’ and ‘A2’ in FIG. 3A are associated with the WINTER SPORTS 166b and SUMMER SPORTS 166a dimension categories respectively, they are both shown on the visualized KPIs of FIG. 5. With respect to the SUMMER SPORTS 166a dimension category, the annotation 172b shows that the sales for SUMMER SPORTS 166a have been annotated to indicate that “Summer sales not keeping pace with Winter products”. For the WINTER SPORTS 166b dimension category, the annotation 172a is still visible even though the visualization has been altered because the annotation 172a is associated with the WINTER SPORTS 166b dimension category as well as the SKI 166c dimension category.

A dimension category 166 may correspond and be related to other dimension categories 166. An example of this is the WINTER SPORTS 166b dimension category encompassing the SKI 166c dimension category.

In some embodiments, the relationship between the dimension categories 166 may be more explicitly indicated. For example, the relationship of the ‘Seasonal Type’ dimension categories 166A encompassing the ‘Product Type’ dimension categories 166B can be stored separately (e.g., in a separate table in intermediate table database 160). In some embodiments, the relationship may be stored as a parent-child hierarchical relationship.

In such embodiments, an annotation 172 associated with a ‘Product Type’ dimension category 166B may automatically be associated with its parent ‘Seasonal Type’ dimension category 166A that encompasses it. When rendering the visualization of the KPI for a particular dimension category 166, the dashboard generator 190 can be configured to determine if the particular dimension category 166 has any children dimension categories 166 so that any annotations 172 for the children dimension categories 166 may also be rendered.

In some embodiments, nested child dimension category 166 hierarchies may also be stored.

Another example of dimension categories 166 will now be explored to illustrate the scenario when date dimension categories 166 may be employed.

Referring to FIG. 3B, shown there generally as 162b is a schematic illustration similar to that of the intermediate table of FIG. 3A except that the date ranges are selected to be dimension categories 166. As with FIG. 3A, the schematic diagram 162b illustrates the dimension categories 166 (the Months 166g, 166h, 166i, 166j, 166k, 166l and Quarters 166C, 166D in this example) as columns. As illustrated, annotations 172 are associated only with the product with product identifier 306 ‘P1’ that is associated with the SKI dimension category 166c shown in FIG. 3A.

As discussed, dimension categories 166 may correspond and be related to other dimension categories 166. The relationships between different date dimension categories 166 may be automatically identified by a dashboard generator 190 as they typically do not change across different sets of intermediate values 164. For example, a ‘Year’ dimension category 166 may encompass a ‘Quarter’ dimension category 166, which may in turn encompass a ‘Month’ dimension category 166. In some embodiments, the hierarchy of relationships for a date dimension category 166 may be defined by known date standards such as Gregorian, Fiscal or ISO 8601 (an international standard based on week numbers).

In FIG. 3B, the relationship between a ‘Month’ dimension category 166 and a ‘Quarter’ dimension category 166 is illustrated with the ‘Quarter’ dimension category column shown in thick outline encompassing the ‘Month’ dimension category 166 columns.

Similar to FIG. 3A, FIG. 3B also shows annotations 172 to the right of the dimension category 166 columns. Annotations 172 associated with particular date dimension categories 166 are similarly marked with an ‘X’ in the column for the date dimension category 166 to which the annotation 172 is associated. As illustrated, there are two annotations 172c, 172d with annotation identifiers 302 ‘A3’ and ‘A4’ corresponding to the ‘May’ 166k and ‘Q2’ 166D dimension categories respectively.

To facilitate the determination of whether an annotation 172 should be displayed in a visualization of a KPI, the annotation 172 may store a date range 310 for which the annotation 172 should be displayed. For example, for the annotation 172c with annotation identifier 302 ‘A3’ associated with the ‘May’ 166k date dimension category, the date range 310 may be stored as ‘May 1-May 31’. Similarly, for the annotation 172d with annotation identifier 302 ‘A4’ associated with a ‘Q2’ 166D date dimension category, the date range may be stored as ‘April 1-June 30’.

To determine if an annotation 172 should be displayed, the dashboard generator 190 may be configured to determine if a date intermediate value 164 corresponding to the date dimension category 166 being visualized corresponds to the date range for the annotation 172. In other words, the dashboard generator 190 may be configured to determine if the date range 310 of an annotation 172 falls within the range for the date dimension categories 166 being visualized in the KPI. If so, the annotation 172 may be displayed; if not, the annotation 172 should not be displayed. For example, an annotation for a ‘May’ 166k dimension category may be displayed for a visualization that uses a ‘Q2’ 166D date dimension category 166 because a ‘May’ date range (May 1-30) would fall within a ‘Q2’ date range (April 1-June 30). That is, the intermediate values 164 being displayed for the date range of the dimension category 166 would correspond to the date range 310 of the annotation 172.

As a result of such association of an annotation 172 with a date dimension category 166, an annotation 172 may “fall off” (i.e., no longer be depicted) if the KPI is subsequently updated to display a date dimension category 166 that no longer corresponds to the date range of the annotation 172. For example, if a KPI that is designed to depict the sales for the most recent three months is accessed in the month of June (such that sales for the months of April through June are depicted), an annotation associated with the month of June would cease to appear once three months has elapsed. This is once three months has elapsed (i.e., the KPI is being subsequently accessed in the month of September), the KPI will have been updated to indicate sales for ‘July’ through ‘September’, and the sales for the month of June (along with the associated annotation 172) will no longer be depicted.

Also similar to FIG. 3A, FIG. 3B shows KPI format data 182 that includes a graphical format 304 that may form part of the dimension category 166 records. As illustrated, the intermediate values 164 corresponding to the date dimension categories 166 (i.e., each of the ‘Jan’ 166g, ‘Feb’ 166h, ‘Mar’ 166i, ‘Apr’ 166j, ‘May’ 166k, and ‘Jun’ 166l dimension categories, as well as the calendar quarter ‘Q1’ 166C and ‘Q2’ 166D dimension categories) are to be depicted as ‘Line Charts’.

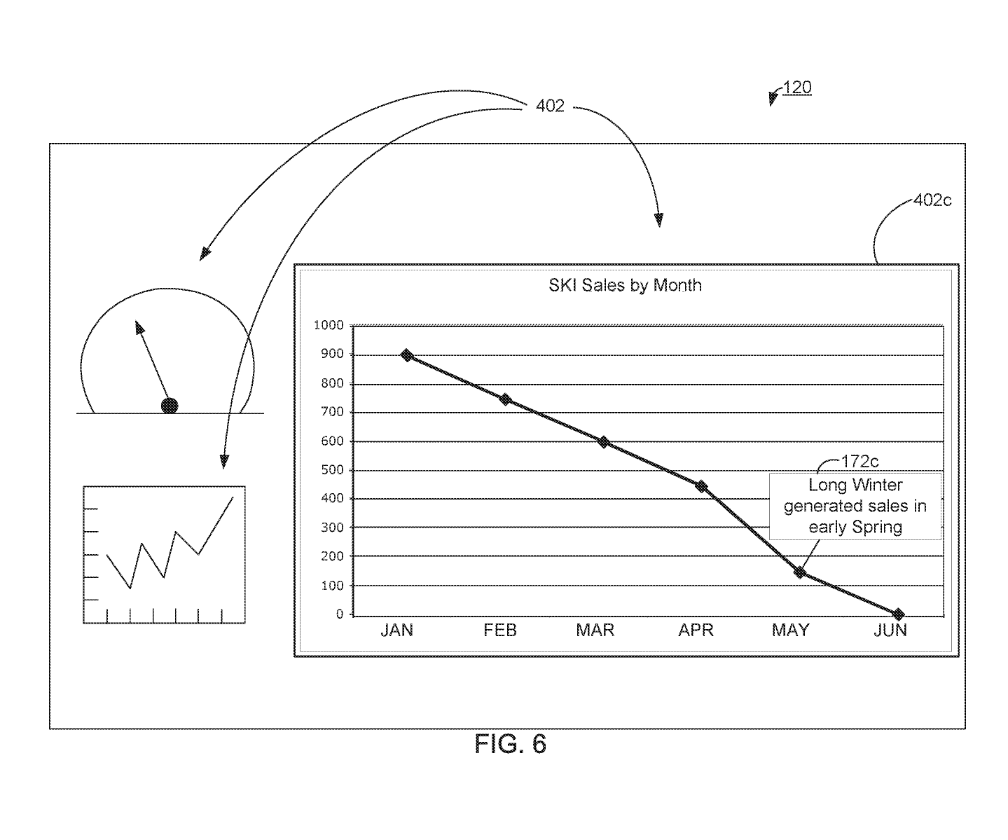

Referring to FIG. 6, shown there generally as 402 (as a part of an example dashboard 120) are various KPI visualizations corresponding to intermediate values 164. Particularly, the KPI visualization 402c corresponds to the intermediate values 164 of FIG. 3B. As illustrated, it can be seen that a line chart KPI visualization 402c for the SKI sales for the months of January to June corresponding to the monthly sales values for the product with product identifier 306 p1 in FIG. 3B is shown. When creating the KPI, a business analyst may wish to provide an annotation to indicate why the sales of SKI products have lasted longer into the Spring season than usual. The business analyst may thus provide an annotation 172c (corresponding to the annotation with annotation identifier ‘A3’ shown in FIG. 3B) associated with the ‘May’ 166k date dimension category indicating “Long Winter generated sales in early Spring”. As noted above, this annotation 172c may then be stored in the annotation database 170 by the dashboard generator 190.

After seeing such visualization 402c, the business analyst may decide that quarterly sales for the SKI product is more appropriate for his/her visualization. As such, they may wish to alter the visualization 402c shown in FIG. 6.

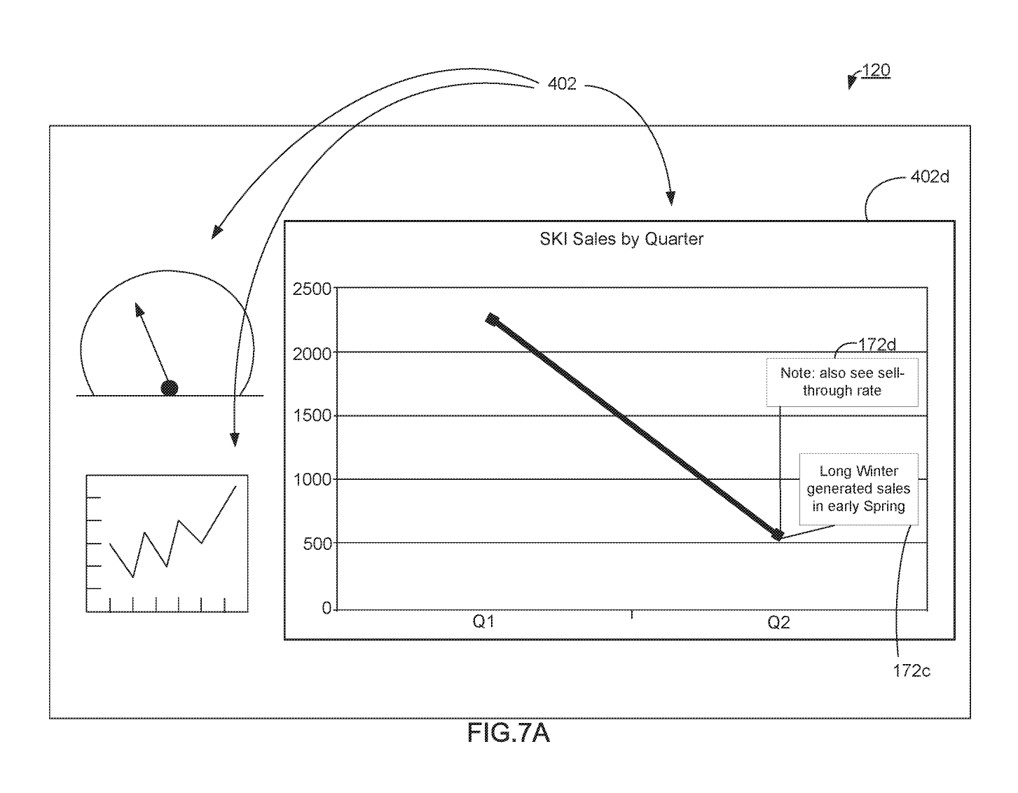

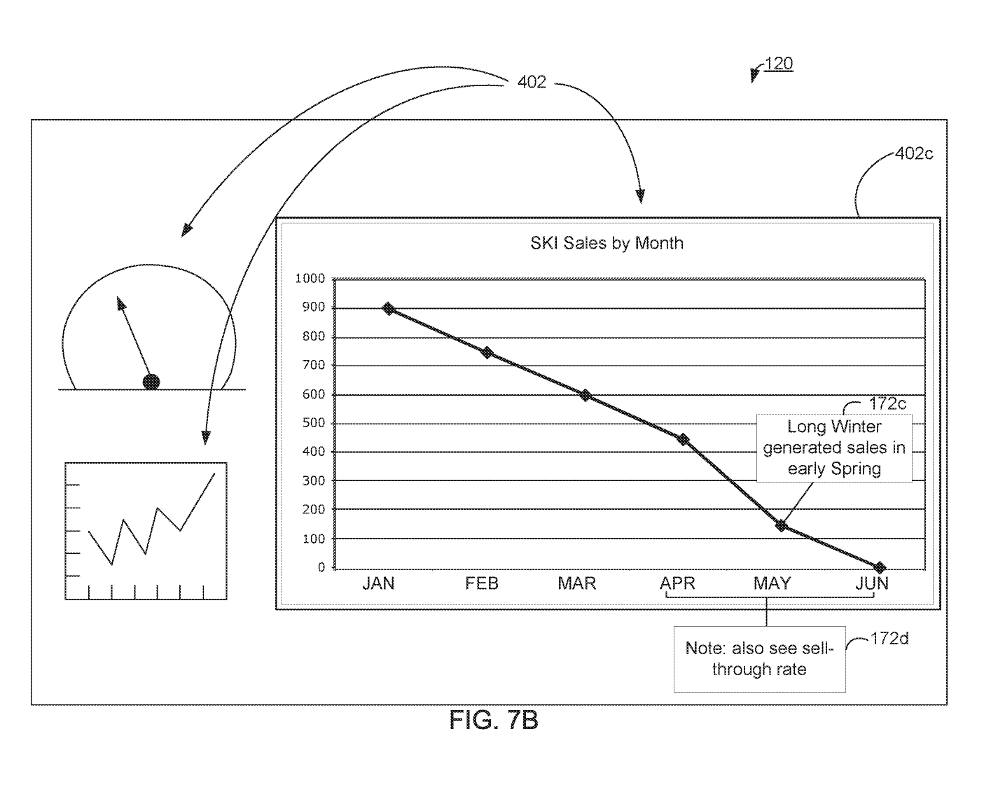

Referring to FIG. 7A, shown there generally is a dashboard 120 having KPI visualizations 402 corresponding to intermediate values 164. Particularly, the KPI visualization 402d is an altered version of the KPI visualization 402c shown in FIG. 6. As illustrated, it can be seen that the visualization 402 has been altered to consolidate the monthly sales totals into quarterly sales totals for ‘Q1’ and ‘Q2’. Also, it can be seen that the business analyst had provided an annotation 172d (corresponding to the annotation with annotation identifier 302 ‘A4’ shown in FIG. 3B) that is a note to viewers of the visualized KPI: “Note: also see the sell-through rate”. It can also be seen that because a ‘Q2’ 166D dimension category encompasses the ‘May’ 166k dimension category, the annotation 172c explaining prolonged SKI sales into the Spring is also rendered.

The steps performed by the dashboard generator 190 in rendering visualizations of the KPI in FIGS. 6 and 7 may be similar to what was described for the visualizations in FIGS. 4 and 5 above.

As illustrated so far, annotations 172 have been associated with a particular data point appearing on a KPI visualization 402 (e.g., the ‘May’ 166k and ‘Q2’ 166D dimension categories 166). In some embodiments, however, annotations 172 may be associated with a range of data points.

Referring to FIG. 7B, illustrated there is a modified version of the dashboard 120 from FIG. 7A, in which the business analyst has, for the KPI visualization 402c, reverted back to the view that shows sales for the ‘SKI’ products by month. In such scenario, since the annotation 172d (with the text “Note: also see sell-through rate”) corresponds to a date range 310 of ‘Apr. 1-Jun. 30’ (as illustrated and discussed above in FIG. 3B), the annotation 172d may be depicted as being associated with a range of data points (i.e., the months ‘APR’ to ‘JUN’) on the KPI visualization 402c.

For example, such association between the annotation 172d and the months of ‘APR’ through ‘JUN’ is depicted as an indicator bracket (encompassing the specified months) being connected to the annotation 172d. It will be understood, however, that other methods of associating an annotation 172 with a range of data values (such as for example, highlighting such values in a different color on the KPI visualization 402c) may also be possible.

Although the examples discussed above refer to date ranges, it will be understood that any time interval (e.g., more granular time units such as hours, minutes or seconds) may be used as date dimension categories 166.

In more complex embodiments, multiple types of dimension categories 166 may be used together to associate with annotations 172. For example, while the examples described have been with regard to ‘Product Type’ and date dimension categories 166 separately, annotations 172 may also be associated with a combination of these dimension categories 166. Further embodiments may include additional dimension categories 166, various combinations of which may be associated with annotations 172.

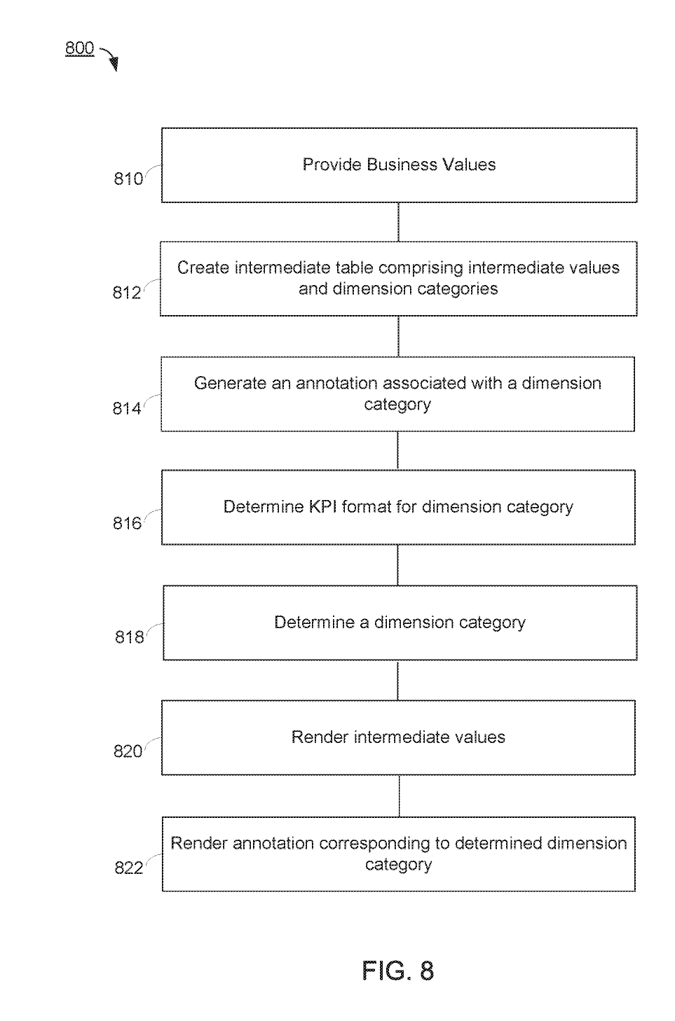

Referring to FIG. 8, shown there is a flowchart illustrating a sequence of events for annotating a dashboard 120, in accordance with one embodiment of the present disclosure. Components of the dashboard generation system 104 described above will be referenced when discussing the blocks in FIG. 8.

At block 810, business values 144 are provided. These business values 144 may, for example, be stored in the business database 142 illustrated and discussed in relation to in FIG. 1 above. Example business values 144 for a sporting goods store including a ‘Sales’ and ‘Inventory’ table are illustrated in FIG. 2.

An intermediate table 162 may then be created by, for example, a database administrator executing a query on the business database 142 (block 812). Examples of an intermediate table 162 for the example sporting goods store are illustrated in FIGS. 3A and 3B. As discussed, the intermediate table 162 may include a plurality of intermediate values 164 and a plurality of dimension categories 166. Each intermediate value 164 may correspond to at least one of the business values 144, and each dimension category 166 may correspond to the intermediate values 164. Also as discussed, the intermediate table 162, intermediate values 164 and dimension categories may be stored in intermediate table database 160.

As illustrated in FIG. 3A, for example, intermediate values 164 for total monthly sales for products with product identifiers 306 ‘P1’ through ‘P4’ are shown. These intermediate values 164 may be associated with particular dimension categories 166. As illustrated, the records with product identifiers 306 are marked with an ‘X’ in the column for the dimension category 166 to which the identified product is associated. For example, product with product identifier 306 ‘P1’ may be associated with a SKI 166c and WINTER SPORTS 166b dimension categories.

An annotation 172 may then be generated (block 814). The annotation 172 may be associated with at least one dimension category 166. Example annotations 172 may be, for example, the annotations 172 with annotation identifiers 302 ‘A1’ and ‘A2’ illustrated in FIG. 3A that are associated with the SKI 166c and WINTER SPORTS 166b dimension categories, and the SUMMER SPORTS 166a dimension category respectively. As discussed above, annotations 172 may be stored separately in annotation database 170, but need not be.

As noted earlier, the content of an annotation 172 may be provided by a business analyst when he/she is reviewing the intermediate values 164 to derive KPI values for visualization. Once entered into the annotation database 170, the annotation 172 may be retrieved from the annotation database 170 for subsequent rendering on the dashboard 120.

To illustrate KPI values derived from intermediate values 164, a KPI graphical format 304 for a dimension category 166 may be determined (block 816). The KPI format 304 may correspond to a desired graphical format 304 (e.g., a bar chart, text list, gauge, or line chart) for depicting the intermediate values 164 corresponding to a dimension category 166. As discussed above, the KPI graphical format 304 may be stored in a KPI database 180 and selected by a business analyst when creating a KPI. Illustrated as being appended to the columns representing the dimension categories 166 in FIG. 3A, a graphical format of ‘bar chart’ may be associated with each of the illustrated ‘Seasonal Type’ and ‘Product Type’ dimension categories 166.

A dashboard may then be generated in the following steps. As discussed above, the following steps may be performed by a dashboard generator 190.

At block 818, one or more dimension categories 166 may be determined. As discussed earlier, a business analyst may input the desired dimension categories 166 to be viewed. The dashboard generator 190 may then determine the dimension categories 166 corresponding to the input from the business analyst.

The intermediate values 164 corresponding to the determined dimension categories 166 may then be retrieved from the intermediate table 162, and rendered by the dashboard generator 190 (block 820). As discussed, in some embodiments, the intermediate values 164 may be further processed to generate KPI values before they are visualized in a KPI visualization 402. If there are any annotations 172 that correspond to the determined dimension categories 166, they may then be rendered (block 822).

As discussed above, FIGS. 4-7 illustrate rendered dashboards having KPI visualizations 402a with annotations 172. In FIG. 4, for example, the annotation 172 “New SKI model generating lots of interest!” is shown as annotated to the total monthly sales for the SKI 166c ‘Product Type’ dimension category.

In some embodiments, at least one of said plurality of intermediate values 164 may include a summary value corresponding to an analysis of a selected subset of business values 144. A summary value may be any value that corresponds to a condensed or processed version of the selected business values 144 that highlights one or more aspects of the selected business values 144. For example, a summary value may be the result of performing a calculation or other analytical procedure (e.g., summation, average) on the selected business values 144. In some instances, the summary value may be determined using a database query of the plurality of business values 144.

As noted, an annotation 172 may include a date range if it is associated with a date dimension category 166. In such embodiments, the method may also include determining, for any annotation 172 corresponding to the determined dimension category 166, if any of the at least one intermediate values 164 corresponding to the determined dimension category 166, also corresponds to the date range for the annotation 172.

As discussed in the example above with regard to FIG. 3B, for an annotation 172 with annotation identifier 302 ‘A4’ corresponding to a ‘Q2’ 166D date dimension (i.e., having a date range 310 of April 1-June 30), this step may involve determining that the intermediate values 164 containing the summed April, May and June monthly sales for the product with product identifier 306 ‘P1’ that corresponds to (i.e., falls within) the date range 310 of the annotation 172. As a result, when the summed values corresponding to the ‘Q2’ 166D dimension category are displayed (i.e., as illustrated in FIG. 7A), the annotation 172d associated with the ‘Q2’ 166D dimension category can also be displayed.

As depicted in the various examples, annotations 172 have been rendered in connection with the rendered data points on a KPI visualization 172. It will be understood, however, that other methods of depicting annotations 172 may be possible. For example, annotations 172 may also be depicted inline on a dashboard with lead lines connecting the annotation 172 to its corresponding data point. Additionally or alternatively, an annotation indicator may be depicted beside one or more data points on the KPI visualization 402 such that when the indicator is accessed (e.g., if a user clicks on or hovers over the indicator), the annotation may be displayed in a separate window.

Referring again to FIG. 3A, it will be understood that what has been shown with respect to the relationships between the intermediate values 164, annotations 172 and dimension categories 166 are illustrative. To implement these relationships, the dashboard generation system 104 may, in some embodiments, store dimension records separately. The intermediate table 162 (and/or the annotation 172 records) may then contain fields that reference the dimension records.

It will be understood by persons skilled in the art that variations are possible in variant implementations and embodiments of the described dashboard creation system 100. Such variations include, but are not limited to, variations in the connectivity amongst described components, the sequence of execution by the described components, the organization of described components, as well as the data structures and types of data stored.

The steps of a method in accordance with any of the embodiments described herein may be provided as executable software instructions stored on computer-readable media, which may include transmission-type media. Such steps may not be required to be performed in any particular order, whether or not such steps are described in claims or otherwise in numbered or lettered paragraphs.

The invention has been described with regard to a number of embodiments. However, it will be understood by persons skilled in the art that other variants and modifications may be made without departing from the scope of the invention as defined in the claims appended hereto.

1-17. (canceled)

18. A method for rendering a dashboard for display on a display device, the dashboard displaying a visualization of data points representing one or more key performance indicator values, the method comprising:
retrieving a plurality of business values from one or more business databases;
deriving a plurality of intermediate values, each intermediate value corresponding to at least one of the plurality of business values retrieved from the business database;
creating an intermediate table, the intermediate table comprising:
the plurality of intermediate values, and
at least two date dimension categories,
wherein a first and a second of the at least two date dimension categories are in a hierarchical relationship;
deriving the one or more key performance indicator values, each of the one or more key performance indicator values corresponding to at least one of the plurality of intermediate values;
storing a first annotation in an annotation database, the first annotation being associated with the first of the at least two date dimension categories;
storing a date range for which the first annotation should be displayed;
storing a second annotation in the annotation database, the second annotation being associated with the second of the at least two dimension categories;
storing a date range for which the second annotation should be displayed, the date range for which the second annotation should be displayed being encompassed by the date range for which the first annotation should be displayed; and
rendering the dashboard for display on the display device,
wherein in response to determining that data points being visualized are consolidated into the first of the at least two date dimension categories and that the date range stored for the first annotation corresponds to the date range for a first data point being visualized, the dashboard is rendered with the first and second annotations displayed in association with the first data point, and
wherein in response to determining that data points being visualized are consolidated into the second of the at least two date dimension categories and that the date range stored for the second annotation corresponds to the date range for a second data point being visualized, the dashboard is rendered with the second annotation displayed in association with the second data point, and with the first annotation displayed in association with data points falling within the first date range.

19. The method of claim 18, wherein rendering the dashboard with the second annotation displayed in association with the second data point comprises rendering an annotation indicator beside the second data point and, in response to receiving user input associated with the annotation indicator, displaying the second annotation in a separate window displayed on the display device.

20. The method of claim 19, wherein the user input associated with the annotation indicator comprises clicking on the annotation indicator.

21. The method of claim 19, wherein the user input associated with the annotation indicator comprises hovering over the annotation indicator.

22. The method of claim 18, wherein rendering the dashboard with the first annotation displayed in association with data points falling within the first date range comprises depicting the first annotation on the dashboard with an indicator bracket connected to the first annotation, the indicator bracket encompassing date dimension category indicators for data points falling within the first date range.

23. The method of claim 18, further comprising storing the intermediate table in an intermediate table database.

24. A computing device comprising a processor and a memory, the processor configured to execute instructions of one or more application modules, the execution of the one or more application modules causing the processor to:
retrieve a plurality of business values from a business database;
derive a plurality of intermediate values, each intermediate value corresponding to at least one of the plurality of business values retrieved from the business database;
create an intermediate table, the intermediate table comprising:
the plurality of intermediate values, and
at least two date dimension categories,
wherein a first and a second of the at least two date dimension categories are in a hierarchical relationship;
derive one or more key performance indicator values, each of the one or more key performance indicator values corresponding to at least one of the plurality of intermediate values;
store a first annotation in an annotation database, the first annotation being associated with the first of the at least two date dimension categories;
store a date range for which the first annotation should be displayed;
store a second annotation in the annotation database, the second annotation being associated with the second of the at least two dimension categories;
store a date range for which the second annotation should be displayed, the date range for which the second annotation should be displayed being encompassed by the date range for which the first annotation should be displayed; and render a dashboard for display on a display device, the dashboard comprising a visualization of data points representing at least one of the derived one or more key performance indicator values,
wherein in response to determining that data points being visualized are consolidated into the first of the at least two date dimension categories and that the date range stored for the first annotation corresponds to the date range for a first data point being visualized, the dashboard is rendered with the first and second annotations displayed in association with the first data point, and
wherein in response to determining that data points being visualized are consolidated into the second of the at least two date dimension categories and that the date range stored for the second annotation corresponds to the date range for a second data point being visualized, the dashboard is rendered with the second annotation displayed in association with the second data point, and with the first annotation displayed in association with data points falling within the first date range.

25. The computing device of claim 24, wherein the execution of the one or more application modules further causes the processor to:
render the dashboard with the second annotation displayed in association with the second data point by depicting an annotation indicator beside the second data point and, in response to receiving user input associated with the annotation indicator, display the second annotation in a separate window displayed on the display device.

26. The computing device of claim 25, wherein the user input associated with the annotation indicator comprises at least one of clicking on the annotation indicator and hovering over the annotation indicator.

27. The computing device of claim 24, wherein the execution of the one or more application modules further causes the processor to:
render the dashboard with the first annotation displayed in association with data points falling within the first date range by depicting the first annotation on the dashboard with an indicator bracket connected to the first annotation the indicator bracket encompassing date dimension category indicators for data points falling within the first date range.

28. The computing device of claim 24, wherein the execution of the one or more application modules further causes the processor to:
store the intermediate table in an intermediate table database.

29. A non-transitory computer-readable storage medium comprising instructions that, when executed by a processor of a computing device, cause the computing device to perform acts of a method of rendering a dashboard for display on a display device, the dashboard displaying a visualization of data points representing one or more key performance indicator values, the acts comprising:
retrieving a plurality of business values from one or more business databases;
deriving a plurality of intermediate values, each intermediate value corresponding to at least one of the plurality of business values retrieved from the business database;
creating an intermediate table, the intermediate table comprising:
the plurality of intermediate values, and
at least two date dimension categories,
wherein a first and a second of the at least two date dimension categories are in a hierarchical relationship;
deriving the one or more key performance indicator values, each of the one or more key performance indicator values corresponding to at least one of the plurality of intermediate values;
storing a first annotation in an annotation database, the first annotation being associated with the first of the at least two date dimension categories;
storing a date range for which the first annotation should be displayed;
storing a second annotation in the annotation database, the second annotation being associated with the second of the at least two dimension categories;
storing a date range for which the second annotation should be displayed, the date range for which the second annotation should be displayed being encompassed by the date range for which the first annotation should be displayed; and
rendering the dashboard for display on the display device,
wherein in response to determining that data points being visualized are consolidated into the first of the at least two date dimension categories and that the date range stored for the first annotation corresponds to the date range for a first data point being visualized, the dashboard is rendered with the first and second annotations displayed in association with the first data point, and
wherein in response to determining that data points being visualized are consolidated into the second of the at least two date dimension categories and that the date range stored for the second annotation corresponds to the date range for a second data point being visualized, the dashboard is rendered with the second annotation displayed in association with the second data point, and with the first annotation displayed in association with data points falling within the first date range.

30. The medium of claim 29, wherein rendering the dashboard with the second annotation displayed in association with the second data point comprises rendering an annotation indicator beside the second data point and, in response to receiving user input associated with the annotation indicator, displaying the second annotation in a separate window displayed on the display device.

31. The medium of claim 30, wherein the user input associated with the annotation indicator comprises clicking on the annotation indicator.

32. The medium of claim 30, wherein the user input associated with the annotation indicator comprises hovering over the annotation indicator.

33. The medium of claim 29, wherein rendering the dashboard with the first annotation displayed in association with data points falling within the first date range comprises depicting the first annotation on the dashboard with an indicator bracket connected to the first annotation, the indicator bracket encompassing date dimension category indicators for data points falling within the first date range.

34. The medium of claim 29, wherein the method further comprises storing the intermediate table in an intermediate table database.
